(19) United States
(12) Patent Application Publication
(10) Pub. No.: US 2024/0157198 A1
(43) Pub. Date: May 16, 2024

(54) System and Method for Interactive Virtual Cycling

(71) Applicant: Watomiq GmbH, Hamburg (DE)

(72) Inventor: Niels Kristian Skov Andersen, Harrislee (DE)

(21) Appl. No.: 18/283,872

(22) PCT Filed: Mar. 25, 2022
(86) PCT No.: PCT/EP2022/058007

§ 371 Date: Sep. 25, 2023

(30) Foreign Application Priority Data
Mar. 25, 2021 (EP) 21164978.5

(51) Int. Cl. A63B 24/00; A63B 22/06

(52) U.S. Cl. CPC A63B 24/0087; A63B 22/0605; A63B 2024/009; A63B 2024/0096

(57) ABSTRACT

The present disclosure regards a computer-implemented method of physically interacting with an exercise bike comprising: receiving an output signal from the exercise bike, said output signal being based on physical activity of a user on the exercise bike; providing real-time visualisation on a display of a digital user avatar representing the user riding a digital bicycle in a virtual cycling game, wherein the user is part of a cycling team comprising at least one virtual team member in addition to the digital user avatar, and wherein a speed of the user in the virtual cycling game is based on the output signal from the exercise bike; and receiving instruction input from the user to control at least one action of at least one of the virtual team members; and updating the virtual cycling game based on said at least one action, such that the user must adjust the physical activity on the exercise bike in order for the digital user avatar to follow along in the virtual cycling game.

The present disclosure relates to a computer-implemented method of physically interacting with an exercise bike and an interactive exercise bike system for a virtual cycling game.

### BACKGROUND

Cycling has been a popular physical activity practised by a wide range of users. Whether it is to boost fitness or health, or a leisure time activity or a professional activity, cycling outdoors may be challenging for a variety of reasons.

During recent years, indoor cycling has gained the attention of many cyclists due to a number of advantages. One advantage is that indoor cycling is controllable such that indoor bikes facilitate setting goals and tracking the progress efficiently. A further advantage is that it is possible to adjust the settings, such as resistance, power and/or speed in an accurate manner. Additionally, indoor cycling provides a great flexibility of being able to adjust training times without the need to consider issues like traffic, day light or weather conditions.

As indoor cycling has grown, so the industries around indoor cycling have been developed further and various types of technology have been incorporated into indoor cycling activities. One of the developments has been in the field of cycling simulators, providing a virtual cycling experience. Virtual cycling systems often comprise a visual display viewed by the user while the system can receive cycling input of the user from a stationary indoor bike. A pre-recorded route can be displayed in accordance with the physical activity, such as pedaling speed, of the user. In some systems, the user is able to steer and explore surroundings. However, such a virtual setting can easily become repetitive and predictable.

An alternative method for offering an enjoyable indoor cycling experience may to combine indoor cycling with a virtual cycling game. The current technology offers participation to virtual cycling games in real-time. A virtual cycling game can therefore be conducted by a plurality of users who are represented in the virtual game. Alternatively, the participant of such a virtual cycling game, i.e., the user of the indoor bike, may be able to select virtual team members and conduct the virtual game with these virtual team members.

While the cycling games enhance the participant's enjoyment of the game, one disadvantage of existing virtual cycling games is that the user is limited in his or her involvement in the team's outcome. Engagement of the user with team members, developing a game strategy and the influence of the user on team members and vice versa is often overlooked in virtual cycling game development. Thus, in a virtual team game, for example, when the team members are virtual team members, the virtual cycling game is limited to the user's performance and the user has very little control on the outcome of the game. As a result, such games can be lacking in challenges and become repetitive.

An interactive cycling system having an interactive virtual cycling team game can be an alternative option in order to achieve an immersive cycling experience. However, a challenge to the conducting of such a game is that the virtual cycling game solely uses data based on the user's physical activity to control the performance in the virtual environment. Not only is the interaction of the user with the virtual game limited to the user's input but the physical activity of the user is also not affected by the user's interaction with the virtual team members. As a result, the current technology in virtual cycling games is limited in its sense of realism for simulating an outdoor cycling experience and real team cycling experiences.

### SUMMARY

The limited sense of reality offered by the current virtual cycling technology becomes more apparent especially when the virtual game is conducted with one or more team members, the influence of the team members on the virtual game progression as well as on the user's physical performance being neglected.

Thus, there is a need in the art for improving the ways of interacting in a virtual team game for having a close-to-reality cycling experience. A further need in the art is allowing the physical participation of a user by means of stationary exercise equipment, such as a stationary bike (indoor bike), while promoting an active participation of the user within the virtual game, i.e. such that the virtual cycling conditions can influence the physical activity of the user.

In a first aspect, the present disclosure relates to a computer-implemented method of physically interacting with an exercise bike, the method comprising the steps of:
receiving an output signal from the exercise bike, said output signal being based on physical activity of a user on the exercise bike;
providing visualisation, preferably in real-time, on a display, for example of a digital user avatar representing the user riding a digital bicycle in a virtual cycling game, preferably comprising and visualising a plurality of digital cyclists,
wherein the user is part of a cycling team comprising at least one virtual team member in addition to the digital user avatar, and wherein speed and/or position of the user in the virtual cycling game is based on the output signal from the exercise bike; and
receiving instruction input from the user on the exercise bike to control at least one action of at least one of the user's virtual team members; and
updating the virtual cycling game based on said at least one action of the virtual team member. For example such that the user must adjust the physical activity on the exercise bike in order for the digital user avatar to follow along in the virtual cycling game.

The steps of receiving instruction input from the user and updating of the virtual cycling game may advantageously be repeated, such as continuously, during the virtual cycling game, for example such that the user at least partly can take control of the virtual cycling game, e.g. by means of the instruction input.

One advantage is that the presently disclosed approach offers an enhanced and sophisticated method for influencing a real-time virtual team cycling game in connection with physical activity of a user operating an exercise equipment. The presently disclosed invention therefore improves the sense of realism when participating in digital cycling games in a virtual/digital environment.

A further advantage of the presently disclosed invention is that the user of a training device, such as an exercise bike, e.g. a smart trainer, can interact with one or more of the user's virtual team members of the virtual game. Thus, the user of the exercise bike can pursue a game strategy where the user can control the virtual team members in the virtual game to take advantage. I.e. the user on the exercise bike with the user's virtual team member(s) such that the physical activity of the user can be influenced from the interaction between the user's digital avatar and one or more virtual team members, from the interaction between virtual team members and/or from the interaction between one or more virtual team members and other virtual cyclists within the virtual game.

Hence, the plurality of digital cyclists may represent virtual digital cyclists, real digital cyclists that represent other users' physical activity on other exercise bikes, or preferably a combination thereof, e.g. in a networked virtual cycling game where other physical users can participate, possibly from different locations, on their own exercise bikes.

Typically, a user on an exercise bike can participate in a virtual cycling game by means of cycling data coming as output from the exercise bike. The data can be related to a power output of the exercise bike wherein the power output, e.g. directly in the form of wattage, is based on the user's physical activity on the exercise bike, the power output is typically determined by the pedaling frequency, an adjustable resistance and possibly also a cycling gear, on the exercise bike. The cycling data is fed into the virtual cycling game thereby corresponding to cycling parameters of the user's digital bicycle in the virtual cycling game.

Typically, the speed of the digital bicycle representing the user in the virtual game is influenced by the power output from the exercise bike, i.e. how much power the user continually generates in the exercise bike by the pedaling motion. Generally, the speed of the user's digital bicycle in the digital game can therefore be adjusted by a variation of the power output of the exercise bike by the user adjusting his physical activity on the exercise bike. However, with the presently disclosed method, the feedback can go the other way as well, i.e. what happens to and around the user's bicycle in the virtual cycling game, i.e. the conditions in the cycling game, can directly influence the amount of physical activity the user must deliver on the exercise bike to keep up with the pace in the virtual cycling game. Virtual cycling conditions in the cycling game may influence the cycling parameters of the user's digital bicycle in the cycling game, game cycling parameters such as speed and position on the digital road in the cycling game. The virtual cycling conditions in the cycling game may be related to gravity, such as cycling uphill or downhill, rolling resistance in the form of varying friction between tires and the road surface, and aerodynamic drag acting on the cycles and cyclists in the cycling game.

Thus, the present disclosure provides a possibility of a two-way interaction wherein the power output of the exercise bike at least partly determines the virtual cycling parameters in the cycling game, and at the same time the physical cycling parameters of the exercise bike, in particular the resistance, can be automatically adjusted based on data received from the cycling game, in particular when there is a change in cycling conditions—and these cycling conditions can be at least partly controlled by the user, e.g. by controlling the user's virtual team members. If for example a virtual team member can provide aerodynamic drag to the user in the cycling game, this results in a change in the virtual cycling parameters, because in the cycling game the user's digital bicycle and corresponding avatar needs less power to follow along behind the virtual team member. This can automatically be fed back to the exercise bike, e.g. by a reduction in the resistance such that the user only need to deliver less power to the exercise bike to follow along in the cycling game. Hence, the physical activity of the user can be influenced by changing conditions in the cycling game.

Hence, in the presently disclosed approach updated cycling conditions in the cycling can be transferred automatically, directly and in real-time to updated operating parameters on the exercise bike, e.g. in the form of adjustment of the resistance or the gear on the exercise bike. Because of a more realistic virtual game, the enthusiasm of the user can be boosted leading to a more enjoyable gaming experience.

The present disclosure further relates to an interactive exercise bike system for a virtual cycling game, wherein a physical user is part of a virtual cycling team comprising at least one virtual team member in addition to the physical user, the interactive exercise bike system comprising:
an exercise bike having at least one variable parameter and configured to generate an output signal based on physical activity of the physical user riding the exercise bike; and
a computer program having instructions, which, when executed by a processing unit, cause the processing unit to:
   receive the output signal from the exercise bike;
   provide real-time visualisation of the user riding a digital bicycle in a virtual cycling game, wherein a speed of the user in the virtual cycling game is based on the output signal from the exercise bike;
      receive instruction input from the user to control at least one action of at least one of the virtual team members in the virtual cycling game; and update the virtual cycling game based on said at least one action such that the user must adjust the physical activity on the exercise bike in order for the digital user avatar to follow along in the virtual cycling game. The computer program may be having instructions, which, when executed by the processing unit, causes the processing unit to execute the any of the steps of the presently disclosed method.

The present disclosure further relates to a computer program having instructions, which, when executed by a processing unit, cause the processing unit to:
receive an output signal from an exercise bike having at least one variable parameter and configured to generate an output signal based on physical activity of a physical user riding the exercise bike; and
provide real-time visualisation of the user riding a digital bicycle in a virtual cycling game, wherein a speed of the user in the virtual cycling game is based on the output signal from the exercise bike;
   receive instruction input from the user to control at least one action of at least one of the virtual team members in the virtual cycling game; and update the virtual cycling game based on said at least one action such that the user must adjust the physical activity on the exercise bike in order for the digital user avatar to follow along in the virtual cycling game. The computer program may be having instructions, which, when executed by the processing unit, causes the processing unit to execute the any of the steps of the presently disclosed method.

Consequently, the physical user of the presently disclosed invention can have a physical and tactical advantage in the virtual game because the user can operate a digital cycling team race by means of his or her physical activity, and tactical considerations may be implemented by means of providing instructions to virtual team members. Consequently, the physical user of the presently disclosed invention can have a physical and tactical advantage in the virtual cycling game because the user can operate a digital cycling team race by the combination of his or her physical activity and tactical cycling skills, taking advantage of virtual team members, i.e. tactical considerations may be implemented by means of providing instructions to virtual team members.

The presently disclosed approach is broadly applicable to exercise bikes where an output signal can be retrieved and wherein one or more parameters on the exercise bike can be automatically adjusted.

The system may comprise a mobile device comprising a processor and a memory and being adapted to perform the presently disclosed methods but it can also by a stationary system or a system operating from a centralized location, and/or a remote system, involving e.g. cloud computing.

The present disclosure further relates to a computer program having instructions which when executed by a computing device or system cause the computing device or system to physically interacting with an exercise bike according to the herein disclosed methods.

### DESCRIPTION OF THE DRAWINGS

The invention will in the following be described in greater detail with reference to the accompanying drawings:

FIG. 1 shows one embodiment of a display unit displaying a virtual cycling game.

FIG. 2 shows one embodiment of a flowchart of a process of conducting a digital cycling game.

### DETAILED DESCRIPTION

As used herein, the phrases “digital cycling game” aka “virtual cycling game” refers to a game in a digital environment.

As used herein, the phrase “digital avatar” refers to a digital representation of a team member of the virtual cycling game and/or the user's own avatar.

The presently disclosed method can preferably provide real-time visualisation, e.g. on one or more display units, of a digital user avatar presenting the user riding a digital bicycle in a virtual cycling game. The visualisation may be in the form of actually displaying the digital user avatar and the bike, or by visualising the ride from a first person viewpoint. Advantageously, the digital user avatar is an avatar representing the user of the exercise bike such that the user can identify himself or herself in the digital game. Thereby, the user can be part of a cycling team comprising at least one virtual team member in addition to the digital user avatar.

In that regard the term “virtual team member” refers to a team member in the cycling game. In the cycling game there are many digital bicycle rider avatars forming the road bicycle race and thereby the cycling game. As in real world cycling each rider is part of a cycling team, typically between five and nine team members on each team, but it could be at least 2 team members and up to 10 or 20 team members in each. The team members on team wear the same clothes such that they can be distinguished, except when one of the team member wears some of the special jerseys, i.e. the lead jersey, possibly yellow like in Tour de France, or the mountain jersey. The user riding the exercise and participating in the cycling game is also part of a team and has virtual team members. The cycling game may be a multiplayer game, i.e. there might be other rider avatars that represent other physical users riding different exercise bikes, either located with the user's exercise bike, and/or remotely located and connected to the cycling game via network connections. But in the presently disclosed approach the at least one of the user's team members is a true virtual team member, which has no physical representative in the real physical world, i.e. the user's virtual team member(s) only exist in the cycling game—and can thereby be controlled by the user. The user might have other team members in the cycling game that represent real physical riders on separate exercise bikes.

The at least one action may be selected from a group of at least three, four or five predefined actions, wherein each predefined action preferably has a different effect of on the required physical activity of the user to follow along in the virtual cycling game.

In one embodiment, the output signal from the exercise bike is received and processed in real-time. The output signal from the exercise bike may relate to speed, power, resistance, steering and/or pedaling frequency, e.g. rounds per minute (RPM), i.e. the output signal is directly related to the physical activity of the user. The speed provided from the exercise bike is a typically a calculation based on the combination of power, resistance, gear and/or RPM. However, the speed provided by the exercise bike does not necessarily take the cycling conditions in the cycling game into account. Hence, in the cycling game there is typically a re-calculation of the speed based on the cycling conditions in the cycling game. The most important input to the cycling game is the real-time power delivered by the user to the exercise bike.

One advantage of the presently disclosed approach is that instruction input can be received from the user to control at least one action of at least one of the virtual team member(s). The cycling game can then be updated based on said at least one action, such that the user must adjust the physical activity on the exercise bike in order for the digital user avatar to follow along in the virtual cycling game. This feature foresees that an interaction between the user of the exercise bike with the virtual team member by means of an instruction input can influence the exercise bike's operating parameters. Thus, the user of the exercise bike adjusts his or her physical activity so that the digital user avatar can perform in the cycling game. Alternatively, the user can adjust his or her physical activity, such as cycling speed, resistance, or his or her interaction with the virtual game by means of an instruction input such that conditions for winning the virtual team game can be approached or satisfied.

In an embodiment, the method is further configured for adjusting an operating parameter of the exercise bike based on said at least one action. Operating parameters of the exercise bike may comprise one or more parameters that are suitable for being adjusted throughout the virtual cycling game in particular the resistance of the exercise bike can be adjusted automatically following the action. Thus, the instruction input of the user is provided for controlling at least one action of at least one of the virtual team members, such that the operating parameters of the exercise bike is adjusted. In a preferred embodiment, the variable parameter of the exercise bike may be a resistance of the exercise bike, such as the resistance of a flywheel of the exercise bike.

The instruction input can be provided by the user as a voice command, via a user interface, keyboard, touch screen, control panel, an input device, or any combination thereof, e.g. the user's smartphone, on the exercise bike. E.g. the user's smartphone can be used as control panel/user interface to control the virtual team members, and/or other commands interfering with the cycling game, whereas the actual cycling game and digital environment can be displayed on the user's smartphone but preferably on another larger screen. Processing of for example the digital visualisation can be provided locally, e.g. by the user's device on the bike or a local computer, but can also be provided by means of central and/or cloud processing, such that multiplayer access and playing can be provided. Being able to provide an instruction input by different means can improve the flexibility of the method and the engagement of the user with the virtual cycling game. Thus, the user can control the virtual team member(s) efficiently while performing a physical cycling activity.

The at least one action is preferably selected from a group of predefined actions. Advantageously, the group of predefined actions may be defined such that the user can select an action to provide instruction input for controlling at least one of the team members such that the user's cycling team gains an advantage or somehow takes control in the cycling race in the cycling game. In a further embodiment, the at least one action is selected from the following: Attack, Protect, High-pace, Reset and Select rider.

In an embodiment, instruction input in the form of High-pace increases the overall speed in the virtual cycling game because at least two of the user's virtual team members take the lead in the virtual cycling game such that the user must increase the RPM, speed and/or the power output of the exercise bike to follow along. When the virtual team members increase the speed cycling, typically in the front of the peloton, the user needs to increase his or her physical activity on the exercise bike. I.e. the user applies a higher power and/or RPM such that the digital user avatar can follow the virtual team members in the cycling game. Hence, an instruction input like High-pace does not necessarily lead to an automatic adjustment of an operating parameter of the exercise bike, but if the user's digital avatar due to the increased speed, starts to fall behind the peloton, the reduced drag and increased wind in the cycling game, resistance from not being in the peloton, eventually leads to an automatic increase of the resistance of the exercise bike, making it even harder for the user to keep up with the others in the cycling game.

Instruction input in the form of Protect can lead to reduction of the resistance on the exercise bike because draft is provided to the digital user avatar in the cycling game from one or more virtual team members relocating in the cycling game to be in front of the digital user avatar, i.e. when the Protect action is activated, at least one virtual team member protects the digital user avatar. As a result, the aerodynamic drag around the digital user avatar changes. The change in the aerodynamic drag in the virtual environment has the effect that the user of the exercise bike can maintain the speed in the cycling with less power and thereby less effort. However, in order to maintain the advantage, the user must stay behind the protecting virtual team member(s); if starting to fall behind, the resistance will again be increased because the drag from the virtual team members is reduced. On the other hand, if the user's digital avatar in the cycling game has fallen behind the peloton and is in a temporary crisis, the Protect action can activate one or more of the user's virtual team members to come down and help the user's digital avatar to get back to the peloton.

In a cycling team, each of the virtual team members may have various physical cycling profiles. In one embodiment, each virtual team member comprises a predefined physical cycling profile defined by one or more parameters selected from the group of: weight, height, maximum power output, average power output and work threshold. Alternatively or supplementary each virtual team member has physical cycling profile corresponding to a predefined rider type, e.g. climber (good in mountains), sprinter (good at the finish line), puncher (good at short climbs) and all-rounder (average rider). I.e. normally the user would not select a climber for the Protect action, because they would not last long. The at least one action by the selected virtual team member, instructed by the user, may reduce a total work capacity by said virtual team member by a predefined amount. Each virtual team member preferably has a predefined total work capacity for use in the virtual cycling game, typically depending on the rider type.

An instruction input in the form of Select selects which virtual team member to subsequently perform an action, and wherein said action's influence in the virtual cycling game depends on the type and/or the physical profile of the selected virtual team member. This implies that the user can select a virtual team member strategically for an action. As a result, the effect of the executed action by the selected virtual team member in the virtual team game on the user's required physical effort can be based on the selected virtual team member's physical cycling profile.

An instruction input in the form of Reset nullifies any action performed by the at least one virtual team member such that the user must adjust the RPM, speed and/or the power output of the exercise bike to follow along.

Additionally, the interactive exercise bike system comprises a variable parameter. Preferably, the variable parameter of the exercise bike is a resistance of the exercise bike, such as the resistance of a flywheel of the exercise bike. Furthermore, output signal from the exercise bike comprises real-time data relating to speed, power and/or pedaling rounds per minute (RPM).

Advantageously, the interactive exercise bike system comprises a display unit for displaying the virtual game. The display unit may be part of a processing unit. In one embodiment, the display unit may be an external display or a screen. This implies that the processing unit can be connected to an external screen. In another embodiment, the display unit can be a part of a tablet or a mobile phone. Advantageously, a computing device such as a mobile phone or a tablet may comprise a network interface for receiving output signal of the exercise bike, and a display unit for displaying, and a processor for executing a software application such that the features described herein can be provided.

Furthermore, the presently disclosure relates to a method configured for updating the output signal of the exercise bike based on the virtual terrain and the speed of the virtual user. In one embodiment, digital user avatar rides on a virtual terrain having a variable surface condition. The surface conditions of the virtual terrain can affect the output signal of the exercise bike. For example, a virtual terrain having a higher friction may result in a higher resistance of the exercise bike.

Preferably, the virtual terrain may have a frictional condition defining a frictional force between a surface of the virtual terrain a tire of the virtual bike. Typically, the frictional force or a frictional constant may be a predefined value affecting the resistance of the exercise bike. However, a surface contact of a bicycle tire with a terrain may change based on a cycling speed. An advantage of the presently disclosed method is therefore to count on the effect of the speed of the virtual bike on the frictional resistance thereby on the output signal of the exercise bike. As a result, the user of the exercise bike may need to adjust his/her physical activity to follow along the virtual game. A further advantage is that, the user of the exercise bike experiences a realistic cycling condition.

For example, when a cyclist cycles on a high-friction terrain at a higher speed, the contact area between the tire(s) and the terrain may be lower. As a result, cycling at a higher speed may result in a lower resistance thereby influencing the power output of the exercise bike based on a speed-resistance coupling. Thus, in an embodiment, a variable parameter of the exercise bike, such as a resistance of the exercise bike may be adjusted based on a relation between the speed of the exercise bike and surface of the virtual terrain.

In prior art cycling exercise systems it is known that cycling uphill or downhill in the digital environment provides a feedback to the exercise bike such that for example the resistance on the bike is updated in accordance with the road condition in the digital environment, i.e. uphill cycling in the digital environment will make it harder to cycle on the exercise bike, in accordance with the slope of the hill and/or the assumed weight of the user. Also wind resistance, i.e. increase in speed leads to more wind resistance in the digital environment and thereby require more effort on the exercise bike—unless draft is provided to the digital user avatar, etc.

However, the present disclosure further relates to situation where the relation between speed and resistance is opposite, such that the resistance added and/or provided to the exercise bike is inversely proportional to the speed of the digital user avatar in the digital environment. This is in particular relevant when the frictional resistance on the road in the digital environment is very high, for example on gravel roads or cobblestones, where the real life situation is that a real road race cyclist will feel that he is “flying” over the cobblestones when he enters a cobblestone passage with high speed, whereas it will be quite tough to ride on the cobblestones if the speed is low. In order to reflect that feeling on an exercise bike, the presently disclosed approach relates to a method wherein the resistance on the exercise bike is adjusted for specific types of road conditions, in terms of frictional resistance and/or road surface, in the digital environment to be inversely proportional to the speed of the digital user avatar in the digital environment. I.e. when riding on a road with high friction, the user has to provide more effort and physical activity to maintain the same speed

Hence, a further embodiment relates to method of controlling a resistance of an exercise bike system, comprising the steps of:
receiving an output signal from an exercise bike, said output signal being based on physical activity of a user of the exercise bike;
providing visualisation of a digital user avatar representing the user riding a digital bicycle in a virtual cycling game on a digital road surface having a roughness, wherein speed of the digital user avatar on the virtual terrain is at least partly based on the output signal from the exercise bike;
adjusting a variable parameter of the exercise bike based on the roughness of the digital road surface, wherein said adjustment is inversely proportional to the speed of the digital user avatar when the roughness is above a predefined threshold and/or when the digital road surface is cobblestones or gravel or dirt track,
updating the speed of the digital user avatar based on the increased roughness of the digital road surface,

This can be continually repeated and updated such that if the speed of the digital user avatar decreases the resistance on the exercise bike will be further increased.

For example if the digital user avatar has a speed of 5 km/h, the resistance is adjusted to be 80% more compared to the present level. With increasing speed the relation can be like this:
5 km/h 80% more
10 km/h 70% more
15 km/h 60% more
20 km/h 55% more
25 km/h 50% more
30 km/h 45% more
35 km/h 40% more
40 km/h 35% more
45 km/h 25% more
50 km/h 20% more
55 km/h 15% more
60 km/h 10% more

I.e. if the user enters the cobblestones with a speed of 60 km/h, the resistance will only be increased by 10%. If during the passage of the cobblestones the speed decreases, the resistance will be added accordingly.

I.e. if the user enters the cobblestones with a speed of 25 km/h, the resistance will be increased as much as 50%, i.e. really tough. If the speed further drops, the resistance will increase further. If the user on the other hand is able to increase the speed by a high effort on the exercise, the resistance will be reduced accordingly.

The present disclosure further relates to a method of using a processing unit and/or a network to conduct a competition involving physical activity of a user on a exercise bike, e.g. physical activity of a user on a exercise bike as exemplified herein. The method comprising the steps of designating a set of parameters for a competition involving the user engaged in physical activity on the exercise bike, the set of parameters defining a win condition requiring physical activity to be completed by said user and reliant upon location data for a digital avatar within a digital bicycle race affected by the physical activity; as also exemplified herein, the digital bicycle race having a number of virtual digital participants and receiving an output signal from the exercise bike, said output signal being based on physical activity of the user on the exercise bike. Determining whether the win condition has been satisfied by the user, one of the user's virtual team members (as described herein) or one of the other digital virtual participants, and identifying a winner as the user, one of the user's virtual team members or one of the other digital virtual participants that completed the win condition. Optionally providing real-time visualisation on a display of the digital user avatar representing the user riding the digital bicycle in the virtual cycling game, wherein a speed of the user in the virtual cycling game is based on the output signal from the exercise bike. As part of the game instruction input can be received from the user to control at least one action of at least one of the virtual team members—as also described herein. And based on said at least one action, the cycling game can be updated, as also described herein. Hence, the win condition can be influenced by the user's physical activity in combination with the user's instructions to the virtual team members. In that regard the user can be both participant in the digital cycling race and satisfy the win condition by performing an excellent physical activity, but also as a role of team captain wherein the user's strategy on how to take advantage of the virtual digital physical abilities of the virtual team members and utilizing that at the right time in the right way during the digital cycling race in order to satisfy the win condition, either of the user or of one of the user's virtual team members. For example the user can save energy, i.e. reduced physical activity, by instructing Protect to one or more of user's virtual team member such that energy is saved during an intermediate period of the digital cycling race, such that the user follows the peloton with reduced physical activity, such that during the period of the digital cycling race, the user may have excess energy and a saved strength to use near the finish of the digital cycling race to satisfy the win condition and win the race.

Computer program/software application used in here shall be construed broadly and include e.g. programs to be run on a PC or software designed to run on smartphones, tablet computers or other mobile devices. Computer programs and mobile applications include software that is free and software that has to be bought, and also include software that is distributed over distribution software platforms such as Apple App Store, Google Play and Windows Phone Store.

### DETAILED DESCRIPTION OF THE DRAWINGS

The present disclosure will now be described more fully hereinafter with reference to the accompanying exemplary embodiments shown in the drawings, when applicable. However, it is to be noted that the invention may be embodied in various forms. The hereby provided embodiments are to guide a thorough and complete disclosure. Hence, embodiments set forth herein should not be interpreted as limiting but be construed as tools for delivering the scope of the invention to those who are skilled in the art. The same reference numbers refer to the same elements throughout the document.

As described previously, the phrases “digital cycling game” or “virtual cycling game” refer to a game in a three-dimensional environment, wherein the digital avatar of the user and the team-member(s) can move by means of physical movement input and/or through a computed movement input. The movement input results in a change in the location of the digital avatar(s) within the digital cycling game. Generally, the physical movement input is based on the physical activity of the user and can be tracked. An advantage of the presently disclosed invention is that the tracked physical movement of the digital avatar of the user and the computed movement of the virtual team member may be temporarily or permanently adjusted during the virtual cycling game.

The exercise bike system may comprise a computing device suitable for communicating with another external electronic device, for example a display unit. Alternatively, the computing device comprises a display and is configured for communicating via a network with a processing unit. Preferably, the computing device is a smartphone comprising a display unit, and a processing unit and a network interface for communicating with the exercise bike. Interfacing and/or communication between the exercise bike, the control panel, the display unit(s) and/or remote processing device may be provide by means of at least one or a combination Bluetooth, wifi, ANT+ or any other form of wired or wireless connection.

The exercise bike comprises a sensing device for tracking physical activity of the user. Furthermore, the exercise bike may be configured such that the resistance of the rear wheel can be adjusted.

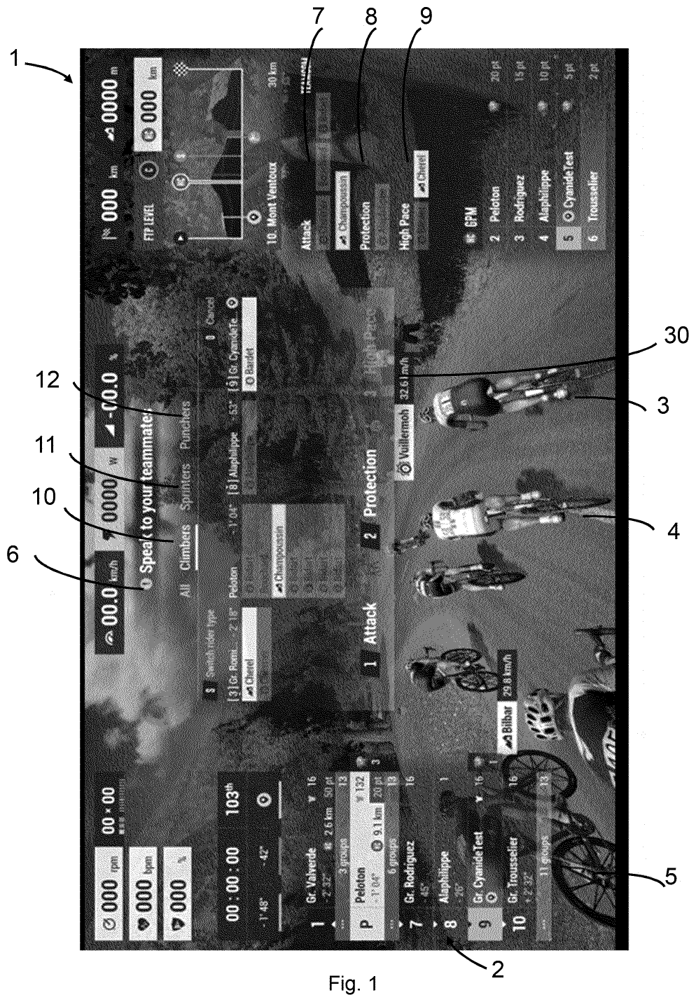

FIG. 1 shows one embodiment of a display unit 1 displaying a virtual cycling game and virtual cyclists 3, 4, 5 and a name list of virtual cyclists 2.

The display unit 1 is configured such that a tracked physical activity of the user or power output from the stationary bike can be received. Data related to the physical activity of the user or the power output can be processed further to show a digitally rendered cycling game wherein the digital avatar of the user moves based on the tracked physical activity of the user or the power output. The display unit 1 can be both a display and a computing device such as a smart phone or any other device having a processing power to render a digital cycling game.

The display unit 1 is further configured to display virtual cyclists' positions during the virtual cycling game, and the virtual cyclists' speed 30. The user of the exercise bike therefore can select a team-member strategically based on a relative position of the virtual team member to the digital user avatar.

An instruction input can be given for controlling at least one action of at least one of the virtual team members. These actions may be selected from a group of actions such as Attack 7, Protect 8, High-pace 9, Reset and Select rider.

FIG. 1 shows that in one embodiment the display unit is configured for receiving the instruction input. The user of the exercise bike can initiate the instruction signal by means of a voice command by engaging with a part 6 of the display unit 1.

Furthermore, each virtual team member comprises a predefined physical cycling profile. The user of the exercise bike can initiate a selection signal for choosing a virtual team member. Furthermore, each virtual team member is a predefined type of cyclist, preferably selected from the group of: climber 10, puncher 12, and sprinter 11.

If the High-pace 9 command is activated selected virtual team-member(s) can increase the overall speed in the virtual cycling game and the user adjust the exercised power on the exercise bike to cycle along with the other team members.

If the Protect 8 command is activated selected virtual team-members reduce the resistance of the exercise bike because draft is provided to the digital user avatar in the virtual cycling environment. Thus, the user can maintain the speed with less physical activity.

Following the action of the virtual team member may lead to a change in the cycling environment, thus the user can adjust the RPM or the speed or the power of the exercise bike. This implies that the change in the virtual environment in the virtual cycling game changes the physical world.

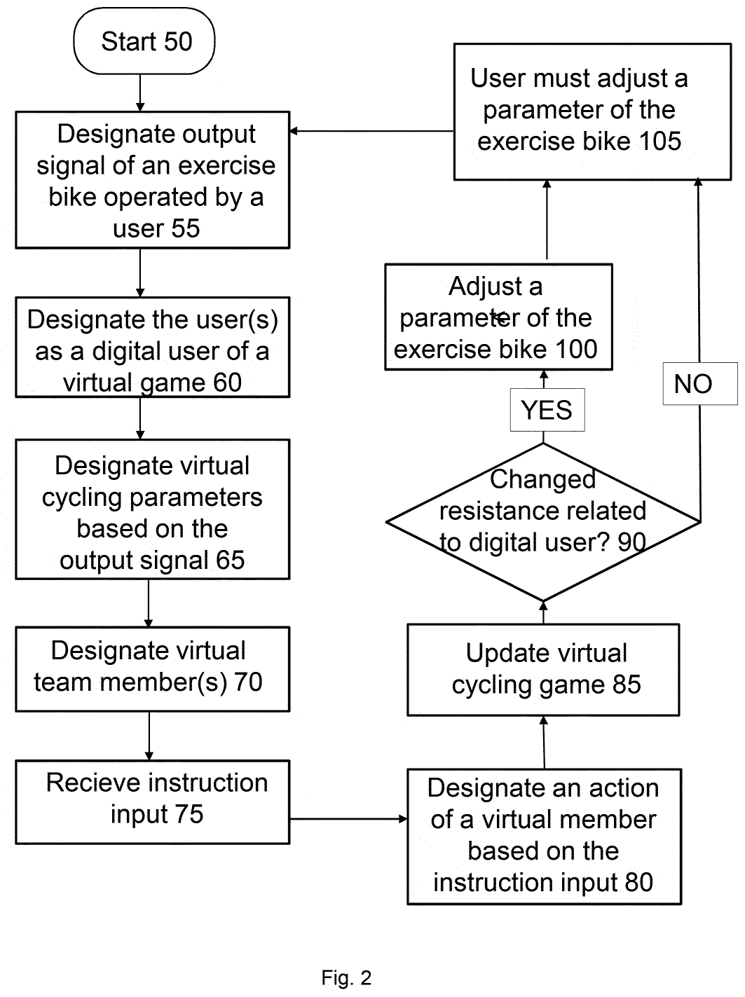

FIG. 2 shows flowchart of a process of interacting with a digital cycling game. The series of process shown in FIG. 2 are primarily the steps of a method for providing a computer-implemented approach of physically interacting with an exercise bike. After the digital cycling game is started at 50, the presently disclosed method designates output signal of an exercise bike operated by a user at 55. Furthermore, the user of the exercise bike is designated as a digital user in the digital cycling game at 60. At this stage, the cycling game may be a single player game or multiplayer game, i.e. there might be other rider avatars that represent other physical users riding different exercise bikes. The virtual cycling parameters, such as speed of the virtual avatar of the user is designated based on the output signal at 65. In the presently disclosed approach the at least one of the user's team members is a true virtual team member, which has no physical representative in the real physical world. Thus, the method further designates virtual team members at 70. The user's virtual team member(s) only exist in the cycling game and can thereby be controlled by the user for example by means of an instruction input at 75. Instruction input can be received to control at least one action of at least one of the virtual team members. The method therefore comprises the step of designating an action of a virtual team member based on the instruction input at 80. The cycling game can then be updated at 85 based on said at least one action, such that the user must adjust the physical activity on the exercise bike at 105. Adjusting the physical activity of the exercise bike is performed so that the digital user avatar can follow along in the virtual cycling game. The physical activity of the user must be adjusted also when the resistance in the digital game related to the digital user changes. If said resistance changes at 90, then an adjustable parameter of the exercise bike is adjusted at 100. This also results in an adjustment of the physical activity of the user, therefore an adjustment of a parameter of the exercise bike at 105.

### Items

1. A computer-implemented method of physically interacting with an exercise bike comprising:
   receiving an output signal from the exercise bike, said output signal being based on physical activity of a user on the exercise bike;
   providing real-time visualisation on a display of a digital user avatar representing the user riding a digital bicycle in a virtual cycling game, wherein the user is part of a cycling team comprising at least one virtual team member in addition to the digital user avatar, and wherein a speed of the user in the virtual cycling game is based on the output signal from the exercise bike; and
   receiving instruction input from the user to control at least one action of at least one of the virtual team members; and
   updating the virtual cycling game based on said at least one action, such that the user must adjust the physical activity on the exercise bike in order for the digital user avatar to follow along in the virtual cycling game.
2. The method according to any of the preceding items, comprising the step of adjusting a variable parameter of the exercise bike based on said at least one action.
3. The method according to item 2, wherein the variable parameter of the exercise bike is a resistance of the exercise bike, such as a resistance of a flywheel of the exercise bike.
4. The method according to any of the preceding items, wherein the output signal from the exercise bike comprises real-time data relating to speed, power and/or pedaling rounds per minute (RPM).
5. The method according to any of the preceding items, wherein the instruction input is provided by the user as a voice command, via a user interface, keyboard, touch screen, and/or an input device on the exercise bike.
6. The method according to preceding items, wherein the at least one action is selected from a group of predefined actions.
7. The method according to preceding items, wherein the at least one action is selected from the group of: Attack, Protect, High-pace, Reset and Select rider.
8. The method according to any of the preceding items, wherein an instruction input in the form of High-pace increases the overall speed in the virtual cycling game because at least two virtual team members take the lead in the virtual cycling game such that the user must increase the RPM, speed and/or the power output of the exercise bike to follow along.
9. The method according to any of the preceding items, wherein an instruction input in the form of Protect reduces the resistance on the exercise bike because draft is provided to the digital user avatar in the virtual cycling game from a virtual team member.
10. The method according to any of the preceding items, wherein each virtual team member comprises a predefined physical cycling profile defined by one or more parameters selected from the group of: weight, height, maximum power output, average power output and work threshold.
11. The method according to any of the preceding items, wherein each virtual team member is a predefined type of cyclist, preferably selected from the group of: climber, puncher, and sprinter.
12. The method according to any of the preceding items, wherein an instruction input in the form of Select rider select which virtual team member to subsequently perform an action, and wherein said action's influence in the virtual cycling game depends on the type and/or the physical profile of the selected virtual team member.
13. The method according to any of the preceding items, wherein an instruction input in the form of Reset nullifies any action performed by the at least one virtual team member such that the user must adjust the RPM, speed and/or the power output of the exercise bike to follow along.
14. An interactive exercise bike system for a virtual cycling game, wherein a physical user is part of a virtual cycling team comprising at least one virtual team member in addition to the physical user, the interactive exercise bike system comprising:
   an exercise bike having at least one variable parameter and configured to generate an output signal based on physical activity of the physical user riding the exercise bike; and
   a computer program having instructions, which, when executed by a processing unit, cause the processing unit to:
      receive the output signal from the exercise bike;
      provide real-time visualisation of the user riding a digital bicycle in a virtual cycling game, wherein a speed of the user in the virtual cycling game is based on the output signal from the exercise bike;
      receive instruction input from the user to control at least one action of at least one of the virtual team members in the virtual cycling game; and
      update the virtual cycling game based on said at least one action, such that the user must adjust the physical activity on the exercise bike in order for the digital user avatar to follow along in the virtual cycling game.
15. The interactive exercise bike system according to any of the preceding items 14, wherein the computer program is having instructions, which, when executed by a processing unit, cause the processing unit to execute the method of any of items 1-13.
16. The interactive exercise bike system according to any of the preceding items 14-15, wherein the variable parameter of the exercise bike is a resistance of the exercise bike, such as a resistance of a flywheel of the exercise bike.
17. The interactive exercise bike system according to any of the preceding items 14-16, wherein the output signal from the exercise bike comprises real-time data relating to speed, power and/or pedaling rounds per minute (RPM).
18. The interactive exercise bike system according to any of the preceding items 14-17, further comprising a display unit for displaying the virtual game.
19. A method of controlling a resistance of an exercise bike system, comprising the steps of:
   receiving an output signal from an exercise bike, said output signal being based on physical activity of a user of the exercise bike;
   providing visualisation of a digital user avatar representing the user riding a digital bicycle in a virtual cycling game on a digital road surface having a roughness, wherein speed of the digital user avatar on the virtual terrain is at least partly based on the output signal from the exercise bike;
   adjusting a variable parameter of the exercise bike based on the roughness of the digital road surface, wherein said adjustment is inversely proportional to the speed of the digital user avatar when the roughness is above a predefined threshold and/or when the digital road surface is cobblestones or gravel or dirt track,
   updating the speed of the digital user avatar based on the increased roughness of the digital road surface,
   optionally repeating the steps above.
20. The method according to item 19, wherein the variable parameter of the exercise bike is a resistance of the exercise bike, such as a resistance of a flywheel of the exercise bike.
21. The method according to any of the items 19-20, wherein the resistance is increased according to the following speeds:
   5 km/h, 80% increased resistance
   10 km/h, 70% increased resistance
   15 km/h, 60% increased resistance
   20 km/h, 55% increased resistance
   25 km/h, 50% increased resistance
   30 km/h, 45% increased resistance
   35 km/h, 40% increased resistance
   40 km/h, 35% increased resistance
   45 km/h, 25% increased resistance
   50 km/h, 20% increased resistance
   55 km/h, 15% increased resistance
   60 km/h, 10% increased resistance.
22. An interactive exercise bike system for a virtual cycling game, the interactive exercise bike system comprising:
   an exercise bike having at least one variable parameter and configured to generate an output signal based on physical activity of the physical user riding the exercise bike; and
   a computer program having instructions, which, when executed by a processing unit, cause the processing unit to:
      receiving an output signal from an exercise bike, said output signal being based on physical activity of a user of the exercise bike;
      providing visualisation of a digital user avatar representing the user riding a digital bicycle in a virtual cycling game on a digital road surface having a roughness, wherein speed of the digital user avatar on the virtual terrain is at least partly based on the output signal from the exercise bike;
      adjusting a variable parameter of the exercise bike based on the roughness of the digital road surface, wherein said adjustment is inversely proportional to the speed of the digital user avatar when the roughness is above a predefined threshold and/or when the digital road surface is cobblestones or gravel or dirt track,
      updating the speed of the digital user avatar based on the increased roughness of the digital road surface,
      optionally repeating the steps above.
23. The interactive exercise bike system according to item 19, wherein the computer program is having instructions, which, when executed by a processing unit, cause the processing unit to execute the method of any of items 1-13 and/or 19-20.

1-25. (canceled)

26. A computer-implemented method of physically interacting with an exercise bike comprising:
receiving an output signal from the exercise bike, said output signal being based on physical activity of a user on the exercise bike;
providing real-time visualisation on a display of a digital user avatar representing the user riding a digital bicycle in a virtual cycling game comprising and visualising a plurality of digital cyclists, wherein the user is part of a cycling team comprising at least one virtual team member in addition to the digital user avatar, and wherein a speed of the user in the virtual cycling game is based on the output signal from the exercise bike; and
a) receiving instruction input from the user to control at least one action of at least one of the virtual team members;
b) updating the virtual cycling game based on said at least one action, such that the user must adjust the physical activity on the exercise bike in order for the digital user avatar to follow along in the virtual cycling game; and
c) repeating steps a) and b) during the virtual cycling game such that the user at least partly can take control of the virtual cycling game by means of the instruction input.

27. The method according to claim 26, further comprising automatically adjusting a variable parameter of the exercise bike based on said at least one action.

28. The method according to claim 27, wherein the variable parameter of the exercise bike is a resistance of the exercise bike.

29. The method according to claim 26, wherein the plurality of digital cyclists represents virtual digital cyclists, real digital cyclists that represent other users' physical activity on other exercise bikes, or a combination thereof.

30. The method according to claim 26, wherein the output signal from the exercise bike comprises real-time data relating to speed, power and/or pedaling rounds per minute (RPM).

31. The method according to claim 26, wherein the instruction input is provided by the user as a voice command, via a user interface, keyboard, touch screen, or an input device on the exercise bike.

32. The method according to claim 26, wherein the at least one action is selected from a group of at least three predefined actions, wherein each predefined action has a different effect of on the required physical activity of the user to follow along in the virtual cycling game.

33. The method according to claim 26, wherein the at least one action is selected from a group of predefined actions selected from the group of: Attack, Protect, High-pace, Reset, and Select rider.

34. The method according to claim 26, wherein an instruction input in the form of High-pace increases the overall speed in the virtual cycling game because at least two virtual team members take the lead in the virtual cycling game such that the user must increase the RPM, speed, or the power output of the exercise bike to follow along.

35. The method according to claim 26, wherein an instruction input in the form of Protect reduces the resistance on the exercise bike because draft is provided to the digital user avatar in the virtual cycling game from a virtual team member.

36. The method according to claim 26, wherein each virtual team member comprises a predefined physical cycling profile defined by one or more parameters selected from the group of: weight, height, maximum power output, average power output, and work threshold.

37. The method according to claim 26, wherein the at least one action by the selected virtual team member reduces a total work capacity by said virtual team member by a predefined amount.

38. The method according to claim 26, wherein the user is part of a cycling team comprising at least three virtual team members in addition to the user.

39. The method according to claim 26, wherein each virtual team member is a predefined type of cyclist selected, by the user, from the group of: climber, puncher, and sprinter.

40. The method according to claim 26, wherein the user is part of a cycling team comprising at least three virtual team members in addition to the user, and wherein the virtual team member are different type of cyclists.

41. The method according to claim 26, wherein an instruction input in the form of Select rider selects which virtual team member to subsequently perform an action, and wherein said action's influence in the virtual cycling game depends on the type or the physical profile of the selected virtual team member.

42. The method according to claim 26, wherein an instruction input in the form of Reset nullifies any action performed by the at least one virtual team member such that the user must adjust the RPM, speed, or the power output of the exercise bike to follow along.

43. An interactive exercise bike system for a virtual cycling game, wherein a physical user is part of a virtual cycling team comprising at least one virtual team member in addition to the physical user, the interactive exercise bike system comprising:
an exercise bike having at least one variable parameter and configured to generate an output signal based on physical activity of the physical user riding the exercise bike; and
a non-transitory computer readable medium containing a computer program comprising instructions, which, when executed by a processing unit, cause the processing unit to:
receive the output signal from the exercise bike;
provide real-time visualisation of the user riding a digital bicycle in a virtual cycling game, wherein a speed of the user in the virtual cycling game is based on the output signal from the exercise bike;
receive instruction input from the user to control at least one action of at least one of the virtual team members in the virtual cycling game; and
update the virtual cycling game based on said at least one action, such that the user must adjust the physical activity on the exercise bike in order for the digital user avatar to follow along in the virtual cycling game.

44. The interactive exercise bike system according to claim 43, wherein:
the virtual cycling game comprises and visualizes a plurality of digital cyclists; and
in the virtual cycling game, the user is part of a cycling team comprising at least one virtual team member in addition to the user.

45. The interactive exercise bike system according to claim 43, wherein the variable parameter of the exercise bike is a resistance of the exercise bike, and wherein the output signal from the exercise bike comprises real-time data relating to speed, power, or pedaling rounds per minute (RPM).

46. A method of controlling a resistance of an exercise bike system, comprising the steps of:
receiving an output signal from an exercise bike, said output signal being based on physical activity of a user of the exercise bike;
providing visualisation of a digital user avatar representing the user riding a digital bicycle in a virtual cycling game on a digital road surface having a roughness, wherein speed of the digital user avatar on the virtual terrain is at least partly based on the output signal from the exercise bike;
adjusting a variable parameter of the exercise bike based on the roughness of the digital road surface, wherein said adjustment is inversely proportional to the speed of the digital user avatar when the roughness is above a predefined threshold and/or when the digital road surface is cobblestones or gravel or dirt track,
updating the speed of the digital user avatar based on the increased roughness of the digital road surface.

47. The method according to claim 46, wherein the variable parameter of the exercise bike is a resistance of the exercise bike.

48. The method according to claim 46, wherein the resistance is increased according to one or more of the following speeds:
5 km/h, 80% increased resistance
10 km/h, 70% increased resistance
15 km/h, 60% increased resistance
20 km/h, 55% increased resistance
25 km/h, 50% increased resistance
30 km/h, 45% increased resistance
35 km/h, 40% increased resistance
40 km/h, 35% increased resistance
45 km/h, 25% increased resistance
50 km/h, 20% increased resistance
55 km/h, 15% increased resistance
60 km/h, 10% increased resistance.

49. The interactive exercise bike system according to claim 46, wherein the variable parameter of the exercise bike is a resistance of a flywheel of the exercise bike.
